(19) United States
(12) Patent Application Publication
(10) Pub. No.: US 2026/0050917 A1
(43) Pub. Date: Feb. 19, 2026

(54) Payment Credential Protection

(71) Applicant: American Express Travel Related Services Company, Inc., New York, NY (US)

(72) Inventor: Alaric M. Eby, Scottsdale, AZ (US)

(21) Appl. No.: 18/802,798

(22) Filed: Aug. 13, 2024

(51) Int. Cl. G06Q 20/38

(52) U.S. Cl. CPC G06Q 20/3829

(57) ABSTRACT

Disclosed are various embodiments for protecting payment credentials. A request for a double-encrypted token payload (dETP) can be received from a payment initiator, the request comprising a merchant identifier and an amount of a transaction. An encrypted token payload (ETP) that represents the payment request and a payment credential can be prepared, the ETP being encrypted with a first encryption key stored on the computing device. The ETP can then be sent to a client application executing on a client device associated with an owner of the payment credential. The dETP can be received from the client application executing on the client device, the dETP being encrypted with a second encryption key stored on the client device. The dETP can then be returned to the payment initiator.

### BACKGROUND

Payment networks (e.g., credit and debit card networks) often receive transaction authorization requests from a wide variety of sources. However, payment networks often lack visibility into the journey that the payment credentials took to reach the originator of the transaction authorization request. Accordingly, payment credentials could be exposed to multiple third-parties prior to the creation of a transaction authorization request by a merchant payment system.

For example, a user could submit payment credentials to a shopping service or assistant that uses machine learning models, such as generative Al, to identify user intents and make purchases on behalf of the user. The shopping service or assistant could, in turn, relay payment credentials to a web-based storefront of a merchant to initiate the checkout process. If the shopping service or assistant were to collect a large enough set of legitimate payment credentials, the machine learning models could be trained to generate seemingly legitimate payment credentials.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting example payment flows according to various embodiments of the present disclosure.

FIG. 2A is a drawing of a network environment according to various embodiments of the present disclosure.

FIG. 2B is a drawing depicting an encrypted token payload (ETP) used within the network environment of FIG. 2A according to various embodiments of the present disclosure.

FIG. 3 is a sequence diagram depicting the issuance of a double-encrypted token payload (dETP) of FIG. 2B within the network environment of FIG. 2A.

FIG. 4 a sequence diagram depicting an example of routing a transaction authorization request containing a double-encrypted token payload (dETP) of FIG. 2B for approval within the network environment of FIG. 2A.

FIG. 5 is a sequence diagram that illustrates the interactions between the payment authorization service, the client application, and the payment routing service of the network environment of FIG. 2A to authorize a payment using a double-encrypted token payload (dETP) of FIG. 2B.

### DETAILED DESCRIPTION

Currently, as generative artificial intelligence (GenAI) continues to evolve, it is expected to be more integrated in the shopping experience generally and the payment experience in particular. This presents new risks for compromise of a payment credential during the shopping or payment experience. Moreover, if not sufficiently protected, a population of “in-the-clear” or payment credentials could be used to train a GenAI model to identify working payment credentials, which could expose users and banks to additional security threats. Moreover, traditional multi-factor authentication (MFA) and other security technologies are insufficient in tackling this threat.

Accordingly, disclosed are various approaches for protecting payment credentials prior to their submission to a payment network. The various approaches of the present disclosure involve a double-encryption approach to protect a payment credential through the entire payment flow or payment journey from a client device through any number of intermediaries before the payment credential is submitted to a payment network by a merchant. Such an approach protects the payment credential from being included, for example, in the training data of a generative Al model that could be used with various customer or user facing systems.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

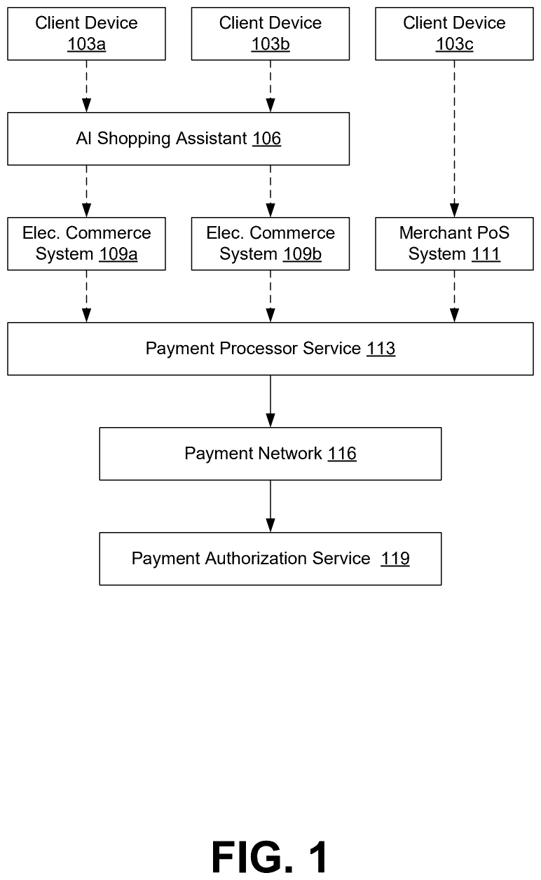

FIG. 1 depicts examples of the flow of payment information from a user (e.g., a credit card holder) to the issuer (e.g., a bank that issued the credit card to the user) in different types of transactions. Solid lines show portions of the flow of payment information that are visible to the bank, while dashed lines show portions of the flow of payment information that are invisible to the bank. Portions of the flow of payment information that are invisible to the bank (represented by dashed lines) may be reported to the bank or inferred by the bank from other sources of information, but the knowledge of these portions may be incomplete or unreliable.

For instance, individual users of client devices 103 (e.g., client devices 103a, 103b, and 103c) can elect to make purchases through various channels. For example, the users of client devices 103a and 103b could use an artificial intelligence (AI) shopping assistant 106 to make purchases on their behalf from various electronic commerce systems 109 (e.g., electronic commerce systems 109a and 109b). This could occur, for example, if a user submitted a prompt to a large language model (LLM) or small language model (SLM) enabled shopping assistant to purchase various goods or services from an internet merchant or sales platform on the user's behalf (e.g., AMAZON®, EBAY®, or various merchants that have an internet storefront that enables the sales of goods and services to customers). As another example, a user of client device 103c could pay for goods or services in-store by using a mobile wallet application (e.g., APPLE PAY®, GOOGLE WALLET®, etc.) to submit payment information to the merchant point of sale (PoS) system 111 (e.g., a payment terminal).

In situations involving an Al shopping assistant 106, the AI shopping assistant could initiate the purchase and checkout process with the electronic commerce systems 109 of the respective merchants. From the perspective of the electronic commerce systems 109, and therefore the merchants operating the electronic commerce systems 109, the AI shopping assistant 106 is indistinguishable from, or nearly indistinguishable from, the client device 103 of the user who initiated the purchase and payment journey. Accordingly, as the AI shopping assistant 106 completes a transaction with an electronic commerce system 109 of a merchant, the electronic commerce system 109 could initiate its preexisting payment authorization process.

Each submission of payment information from the client devices 103 to the first leg in the flow is invisible to the issuing bank. The issuing bank is unaware of the identity of the user and the identity of the merchant, nor how the payment credentials submitted to the merchants are protected (if at all). For example, stolen payment credentials could be submitted for an unauthorized purchase to a legitimate merchant. As another example, a fraudulent merchant could create a fake payment request by reusing payment credentials previously submitted by another user. As another example, the AI shopping assistant 106 could hallucinate and reuse another individual's previously submitted payment credentials, or payment credentials included in the training data for the Al shopping assistant 106, to make a purchase authorized by a first user with the payment credentials of a second user.

In the next step in the flow of payment information, the merchants can create transaction authorization requests based on the payment information and transaction information. The transaction authorization requests can be submitted by individual merchant systems (e.g., electronic commerce systems 109 or merchant PoS systems 111) to the payment processor service 113, which is operated by the payment processor of the merchants. Although a single payment processor service 113 is depicted to show that multiple merchants could use the same payment processor service 113 provided by the same payment processor (also sometimes referred to as a payment aggregator), it should be noted that in a large payments ecosystem there would be a large number of merchants using a variety of respective payment processors, each of which operates its own payment processor service 113. The payment processor could

[symbol]

Then, the payment processor service 113 can submit the payment requests to the payment network 116. The payment network 116 could then route individual payment requests to the appropriate payment authorization service 119 operated by a respective issuing bank. In closed-loop payment networks (e.g., the AMERICAN EXPRESS® or DISCOVER® payment networks), where the payment network 116 and the payment authorization service 119 are operated by the same entity, usually the issuing bank or a parent company of the issuing bank, this is the first point in time where the issuing bank will have direct knowledge of the flow of payment information. However, in open-loop payment networks (e.g., the MASTERCARD® or VISAR payment networks), the issuing bank will not have direct knowledge of the flow of payment information until the payment network 116 forwards the payment authorization request to the payment authorization service 119 operated by the issuing bank. Moreover, in either situation, the payment authorization service 119, and therefore the issuing bank, will generally see transaction authorization requests coming from the same payment processor service 113 rather than from individual merchants (e.g., individual electronic commerce systems 109 or merchant PoS systems 111).

Once the payment authorization service 119 receives a transaction authorization request for a payment, the payment authorization service can evaluation the request and make a decision as to whether the transaction should be approved or declined. The response can be returned along the same path—the response be submitted to the payment network 116, which routes the response to the appropriate payment processor service 113, which returns the approval or rejection decision to the electronic commerce system 109 or merchant PoS system 111.

As illustrated in the payment flow diagram of FIG. 1, payment credentials for a transaction could pass through any number of intermediate parties. These intermediate parties are also not necessarily known to the other parties in the flow. For example, an electronic commerce system 109, payment processor service 113, payment network 116, and/or payment authorization service 119 may be unaware of the existence of the Al shopping assistant 106. Similarly, the payment network 116 and/or the payment authorization service 119 may be unaware of which merchant (and therefore which electronic commerce system 109 or merchant PoS system 111) a payment originated from because the payment processor service 113 submits the transaction authorization requests to the payment network 116 on their behalf.

A number of problems arise as a result. First, because many parties in the payment flow are aware of the existence of every party in the payment flow, payment credentials could pass through insecure, untrusted, or unauthorized third-parties. These unknown third-parties could use their position in the payment flow to capture payment credentials for later use. For example, the AI shopping assistant 106, if trained on a large enough dataset of payment credentials, could learn to create counterfeit payment credentials for use in future transactions. Electronic commerce applications 109 operated by less than reputable merchants could copy and store payment credentials for use in future, fraudulent transactions. Moreover, it can be hard to detect whether a payment request made on behalf of a user has not been modified. For example, the AI shopping assistant 106 could hallucinate and purchase the wrong item, purchase the correct item for the wrong price, or purchase the wrong amount or number of the item. Individual electronic commerce systems 109 or merchant PoS systems 111 could also modify a payment request without the knowledge of the card holder.

To solve these problems, various embodiments of the present disclosure offer a double-encrypted, end-to-end system for protecting payment credentials and authenticating a transaction. A payment payload can be encrypted initially by the payment authorization service 119. The encrypted payment payload can then be provided to the client device 103 of the card holder, who can use a private encryption key stored on his or her client device 103 to doubly encrypt the payment payload. The payment payload can then be submitted by the user to initial stage in the payment flow (e.g., the double-encrypted payment payload could be submitted to the AI shopping assistant 106 as part of the prompt to make a purchase on behalf of the user). When the double-encrypted payment payload is received by the payment authorization service 119, the payment authorization service 119 can request that the user perform a first decryption using the private encryption key on his or her client device 103. The payment authorization service 119 can then perform a second decryption which, if successful, proves that the payment payload has not been tampered with and that the payment was previously authorized by the user. Moreover, the use of encryption makes the contents of the payment payload indecipherable to any parties who handle the payment payload during its journey from the client device 103 of the user to the payment authorization service 119.

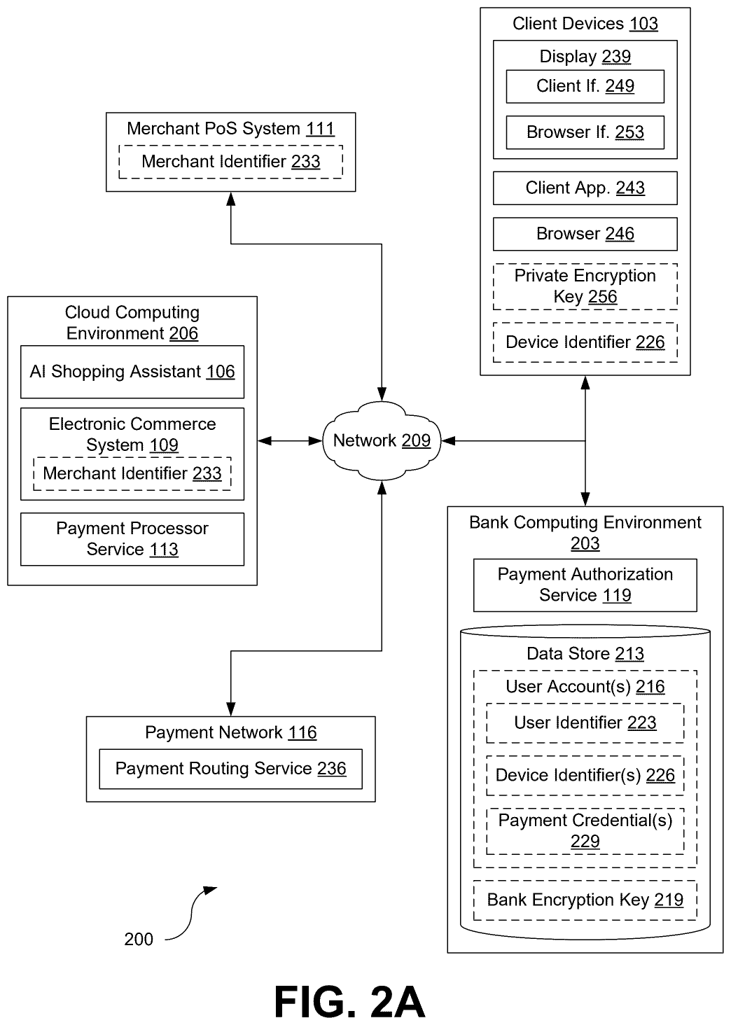

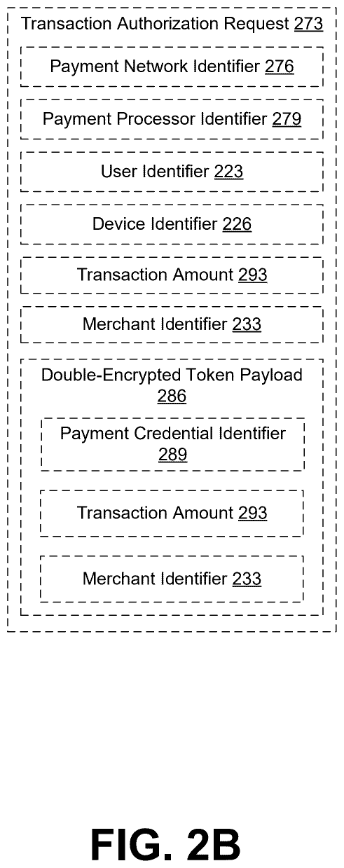

With reference to FIG. 2, shown is a network environment 200 according to various embodiments. The network environment 200 can include one or more client devices 103, one or more merchant POS systems 111, and the payment network 116 as previously discussed in FIG. 1. The network environment 200 can also include a bank computing environment 203 and a cloud computing environment 206. All of these components can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

Although the bank computing environment 203 and the cloud computing environment 206 are depicted separately, this need not always be the case. For example, all of the applications and services executed on and data stored within the bank computing environment 203 and the cloud computing environment 206 could by hosted within a single, multi-tenant computing environment, such as a publicly available cloud computing environment offered by AMAZON®, GOOGLE®, or MICROSOFT®, such as AMAZON WEB SERVICES® (AWS®), GOOGLE CLOUD COMPUTE (GCP®), or MICROSOFT AZURE®. Similarly, all of the applications and services executed on and data stored within the bank computing environment 203 and the cloud computing environment 206 could by separately hosted by separate computing environments (e.g., with some applications or services hosted within private or on-premises computing environments or on separate, publicly available cloud computing environments hosted by different vendors).

Accordingly, both the bank computing environment 203 and the cloud computing environment 206 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, both the bank computing environment 203 and the cloud computing environment 206 can employ a plurality of computing devices that can be arranged in one or more server banks or computer banks or other arrangements. Such computing devices can be located in a single installation or can be distributed among many different geographical locations. For example, both the bank computing environment 203 and the cloud computing environment 206 can include a plurality of computing devices that together can include a hosted computing resource, a grid computing resource or any other distributed computing arrangement. In some cases, the bank computing environment 203 or the cloud computing environment 206 can correspond to an elastic computing resource where the allotted capacity of processing, network, storage, or other computing-related resources can vary over time.

Various applications or other functionality can be executed in the bank computing environment 203. The components executed on the bank computing environment 203 include a payment authorization service 119, and other applications, services, processes, systems, engines, or functionality not discussed in detail herein.

The payment authorization service 119 can be executed to evaluate transaction authorization requests, sometimes also referred to as payment authorization requests, and determine whether to approve or reject the transaction authorization request. The payment authorization service 119 can be executed to generate a double-encrypted token payload (ETP) 286 (FIG. 2B) and to decrypt a dETP 286 presented to it by the payment network 116 on behalf of a payment processor service 113. A decrypted dETP 286 can then be evaluated by the payment authorization service 119 to determine whether to approve or reject the transaction (e.g., by the application of various credit, fraud, and risk rules).

Also, various data can be stored in a data store 213 that is accessible to the computing environment 203. The data store 213 can be representative of a plurality of data stores 213, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 213 is associated with the operation of the various applications or functional entities described below. This data can include one or more user accounts 216 representing individual users or customers of the issuing bank that operates the payment authorization service 119, a bank encryption key 219 for use in encrypting and decrypting ETPs and dETPs, as well as potentially other data.

Each user account 216 can represent an individual user or customer (e.g., a card holder) of the issuing bank that operates the payment authorization service 119. Accordingly, individual user accounts 216 can store various information about a respective user or customer. This information can include a user identifier 223, one or more device identifiers 226, and one or more payment credentials 229. Each user account 216 can also store additional information about individual users as desired for various embodiments of the present disclosure.

The user identifier 223 can include any identifier that uniquely identifies a user account 216 with respect to another user account 216. Examples of user identifiers 223 can include usernames, globally unique identifiers (GUIDs), universally unique identifiers (UUIDs), etc. In some implementations, a user account 216 can have multiple user identifiers 223 (e.g., a username and a GUID or UUID).

The device identifiers 226 can include any identifier that uniquely identifiers a client device 103 with respect to another client device 103. Examples of device identifiers 226 can include hardware identifiers unique to individual client devices 103 (e.g., serial numbers, International Mobile Equipment Identity (IMEI) numbers, media access control (MAC) addresses, etc.) or identifiers assigned to and stored on the client device 103 (e.g., UUIDs or GUIDs assigned to and stored on client devices 103).

The payment credentials 229 can represent information related to payment accounts or methods (e.g., credit, charge, or debit card accounts; demand deposit accounts such as checking accounts; etc.) owned or controlled by the user. Each payment credential 229 can include any information related to the payment account or method that a user would need to complete or make a payment, such as an account number (e.g., credit, charge, or debit card account number; a demand deposit account number; etc.); name associated with the payment credential; security features (e.g., card security code (CSC); card verification value (CVV); etc.); expiration date associated with the payment credential; billing address associated with the payment credential; etc. In some instances, a payment credential 229 could include multiple, unique account numbers. This could occur, for example, when virtual or temporary account numbers have been issued to a credit, charge, or debit card, as can happen when a payment credential has been tokenized.

The bank encryption key 219 can represent any private or secret encryption key that can be used by the payment authorization service 119 for encrypting and decrypting data, such as dETPs 286, using an encryption algorithm. Although any encryption algorithm can be used, symmetric encryption algorithms where the same encryption key is used to encrypt and decrypt data may be preferred for performance reasons. Accordingly, the bank encryption key 219 could be a 128-bit, 192-bit, or 256-bit encryption key for use with symmetric encryption algorithms such as the Advanced Encryption Standard (AES) algorithm.

In some instances, the bank encryption key 219 could be a single use encryption key. In these instances, a new bank encryption key 219 could be generated by the payment authorization service 119 using a key-generation algorithm for each ETP. In these implementations, the bank encryption key 219 could include a key identifier. The key identifier could also be associated with a respective dETP 286 as part of a transaction authorization request 273 to allow the payment authorization service 119 to determine which bank encryption key 219 to use to decrypt the dETP 286 at a later point in time.

Moreover, various applications or other functionality can be executed in the cloud computing environment 206. The components executed on the cloud computing environment 206 include one or more Al shopping assistants 106, one or more electronic commerce systems 109, and/or one or more payment processor services 113, as well as other applications, services, processes, systems, engines, or functionality not discussed in detail herein.

The AI shopping assistant 106 can be executed to assist users in procuring or purchasing items available for sale or lease through electronic commerce systems 109 of various merchants. The AI shopping assistant 106 can make use of various machine learning models, such as large language models (LLMs) or small language models (SLMs), or other natural language processing techniques to determine a user intent from a prompt submitted to the AI shopping assistant 106. Large language models are machine learning models the allow for general-purpose language generation, processing, and classification and are considered to be “large” due to the number of weights and parameters used by the model, which can be hundreds of billions of parameters. Examples of large language models are machine learning models that use transformers, such as generative pre-trained transformers (GPTs) or bidirectional encoder representations from transformers (BERTs). In contrast, small language models are machine learning models that use transformers, such as GPTs or BERTs, but use a smaller number of weights and parameters. Small language models are often trained on smaller data sets and, therefore, perform similarly to LLMs within a domain of knowledge for which the SLM is trained, but tend to perform more poorly outside of the domain of knowledge for which the SLM is trained. In contract, LLMs tend to perform well across a wide variety of knowledge domains due to their larger training corpus and far larger number of weights and parameters. Examples of LLMs include the various versions of OPENAI's ChatGPT, Meta AI's® Llama, GOOGLE® Gemini, etc.

The AI shopping assistant 106 can attempt to perform, execute, or otherwise honor the user intent identified by the use of a machine learning model, such as an LLM or SLM. For example, a user could submit a prompt to the AI shopping assistant 106 to purchase a blue, cotton, button-down dress shirt in a particular size. In some instances, the prompt could include the preferred or appropriate payment credential to use to complete the purchase. The AI shopping assistant 106 could then scrape data from one or more electronic commerce systems 109 and initiate a purchase or checkout process based on the prompt and using the payment credential provided by or identified by the user. Accordingly, the AI shopping assistant 106 can include a front-end interface, such as a web page or mobile application, through which a user can submit prompts to cause the AI shopping assistant 106 to perform in the desired manner.

The electronic commerce system 109 can be executed to facilitate the online purchase or lease of items or services over the network 209. The electronic commerce system 109 can also performs various backend functions associated with the online presence of a merchant in order to facilitate the online purchase of item. For example, the electronic commerce system 109 can generate web pages that are provided to users (e.g., client devices 103, AI shopping assistants 106, etc.) for the purpose of selecting items for purchase, rental, download, lease, or other form of consumption. Moreover, electronic commerce systems may include payment processing functionality that, in response to submission of an order and payment credentials, can create and submit a transaction authorization request to the payment processor service 113 operated by the acquirer or payment processor of the merchant operating the electronic commerce system 109. In some instances, the electronic commerce system 109 can store a merchant identifier 233 assigned to it by the payment processor service 113.

The payment processor service 113 can be executed to accept payment and transaction information from a merchant or merchant system (e.g., an electronic commerce system 109 or a merchant PoS system 111) and request authorization for the transaction by submitting a transaction authorization request (sometimes referred to as a payment authorization request) to the payment routing service 236 of the payment network 116. Accordingly, the payment processor service 113 can be determine which payment network 116 is appropriate to send the transaction authorization request based at least in part on the type of payment credential 229 being used. The payment processor service 113 can generate an appropriate transaction authorization request for the identified payment network 116 and send it to the payment routing service 236 of the payment network for delivery to the payment authorization service 119 of the appropriate issuing bank.

One or more merchant point-of-sale (PoS) systems 111 can also be connected to the network 209 within the network environment 200. A merchant PoS system 111 can be physical or virtual. Physical merchant PoS systems 111 can include payment terminals, while virtual merchant PoS systems 111 can include software-based payment systems. Individual merchant PoS systems 111 can include a merchant identifier 233 that identifies the merchant who operates the merchant PoS system 111.

A payment network 116 can also be connected to the network 209 within the network environment 200. The payment network 116 can operate a payment routing service 236 for the routing of transaction authorization requests from payment processor services 113 of payment processors to payment authorization services 119 of issuing banks participating in the payment network 116. Similarly, the payment routing service 236 can also return authorization decisions to approve or reject a transaction authorization request from the payment authorization service 119 to the originating payment processor service 113.

One or more client devices 103 can also be coupled to the network 209. A client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 239, such as liquid crystal displays (LCDs), gas plasma-based flat panel displays, organic light emitting diode (OLED) displays, electrophoretic ink (“E-ink”) displays, projectors, or other types of display devices. In some instances, the display 239 can be a component of the client device 103 or can be connected to the client device 103 through a wired or wireless connection.

A client device 103 can be configured to execute various applications such as a client application 243, a browser 246, or other applications. The client application 243 can be executed by a client device 103 to interact with the payment authorization service 119, thereby rendering a client interface 249 on the display 239. An example of a client application 243 can include a mobile wallet application, a mobile banking application, etc. The browser 246 can be executed to interact with an Al Shopping Assistant 106, an electronic commerce system 109, or other applications or services that provide web-based content. Accordingly, the browser 246 can render a browser interface 253 on the display 239, within which web pages or other web-based content provided by the AI shopping assistant 106 or an electronic commerce system 109 can be displayed.

Additional information or data can be stored on a client device 103. This can include a device identifier 226 that uniquely identifies the client device 103 with respect to other client devices 103. This information or data can also include a private encryption key 256, which can be used to generate double-encrypted token payloads (dETPs) 286 according to various embodiments of the present disclosure. The private encryption key 256 can represent any private or secret encryption key that can be used by the client application 243 for encrypting and decrypting data, such as dETPs 286, using an encryption algorithm. Although any encryption algorithm can be used, symmetric encryption algorithms where the same encryption key is used to encrypt and decrypt data may be preferred for performance reasons. Accordingly, the private encryption key 256 could be a 128-bit, 192-bit, or 256-bit encryption key for use with symmetric encryption algorithms such as the Advanced Encryption Standard (AES) algorithm.

In some instances, a private encryption key 256 could be a single-use encryption key. For example, the private encryption key 256 could be generated by the client application 243 using a key-generation algorithm each time a user of the client application 243 approves of a proposed transaction. For instance, the private encryption key 256 could be generated randomly or it could be generated based on a password or passphrase submitted by the user to the client application 243. Accordingly, a key identifier for the private encryption key 256 could be stored on the client device 103 in association with the private encryption key 256 to allow the client application 243 to select the correct private encryption key 256 for a subsequent decryption operation.

Referring next to FIG. 2B, shown is an example of a transaction authorization request 273 (sometimes referred to as a payment authorization request) using within the network environment 200 of FIG. 2A according to various embodiments of the present disclosure. As illustrated, a transaction authorization request 273 can include various types of data, such as a payment network identifier 276, a payment processor identifier 279, and a double-encrypted token payload (dETP) 286. The transaction authorization request 273 can also include a user identifier 223 and/or device identifier 226. The payment network identifier 276 can be used to identify which payment network 116 should be used to route and/or process the transaction authorization request 273. Accordingly, the payment network identifier 276 can include any identifier that can uniquely identify a payment network 116 with respect to another payment network 116. Similarly, the payment processor identifier 279 can be used to identify which issuing bank, and therefore which payment processor service 113, the transaction authorization request 273 should be routed to for approval. Accordingly, the payment processor identifier 279 can include any identifier which can uniquely identify an issuing bank, and therefore a payment processor service 113, with respect to another issuing bank and/or payment processor service 113. The user identifier 223 and/or device identifier 226 can be included in the transaction authorization request 273 to specify which user and/or which client device 103 of the user were used to generate the dETP 286 included in the transaction authorization request 273.

In some implementations, the transaction authorization request 273 could also include key identifiers for a respective bank encryption key 219 and/or private encryption key 256 to allow the payment authorization service 119 and/or the client application 243 to determine which bank encryption key 219 or private encryption key 256 should be used to decrypt the dETP 286.

The dETP 286 represents an encrypted portion of the transaction authorization request 273 which contains sensitive information about the transaction and the payment credential 229 to be used to complete the transaction. Accordingly, the dETP 286 can include a payment credential identifier 289 (e.g., an account number or similar identifier) for the payment credential 229 to be used to pay for the transaction; a transaction amount 293 representing the monetary value or amount of the transaction; and a merchant identifier 233 that identifies the merchant who is the counter-party to the payment. The transaction amount 293 and the merchant identifier 233 can also be stored outside of the dETP 286 as part of the transaction authorization request 273. As discussed later, the dETP 286 can be double-encrypted with both the bank encryption key 219 and the private encryption key 256 to allow for secure transmission of the contents of the dETP 286 and for authentication and verification of the dETP 286.

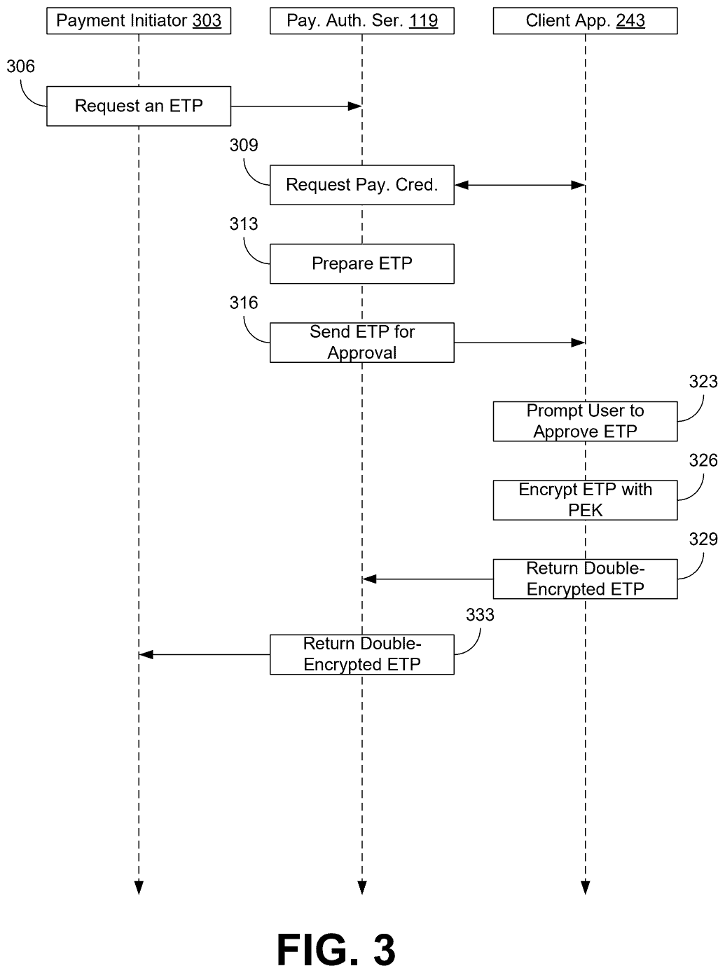

Referring next to FIG. 3, shown is a sequence diagram depicting the issuance of a double-encrypted token payload (dETP) 286 within the network environment 200. The sequence diagram of FIG. 3 provides merely an example of the many different types of functional arrangements that can be employed within the network environment 200. As an alternative, the flowchart of FIG. 3 can be viewed as depicting an example of elements of a method implemented within the network environment 200.

Beginning with block 306, a payment initiator 303 can submit a request for an dETP 286 for a proposed or potential transaction to the payment authorization service 119. A payment initiator 303 can include any application or device that requests the dETP 286 from the payment authorization service 119. The payment initiator 303 could include a browser 246, an Al shopping assistant 106, or an electronic commerce system 109 depending on the nature of any particular transaction.

For example, the payment initiator 303 could submit a request for the dETP 286 using an application programming interface (API) provided by the payment authorization service 119. The request for the dETP 286 could include an amount of a transaction and a merchant identifier 233 identifying the merchant to be paid in the transaction. In some instances, the request for the dETP 286 could also include information that could be used by the payment initiator 303 to identify the user or owner of the payment credential 229 to be used, such as a device identifier 226 of a client device 103 associated with the user account 216 of the user, a user identifier 223 of the user account 216 of the user, or some other identifier.

In some instances, the request for the dETP 286 could include an identifier of the payment credential 229 to be used. Because the request for the dETP 286 could be submitted through a potentially insecure channel or pass through untrusted intermediaries, the request for the dETP 286 should not include the payment credential identifier 289. However, the request for the dETP 286 could include a partial payment credential identifier 289, such as the last four digits of an account number for the payment credential 229. Alternatively, the dETP 286 could include some other identifier for the payment credential 229 that uniquely identifies the payment credential 229 with respect to other payment credentials 229 associated with the user account 216.

Depending on the information provided at block 306, the payment authorization service 119 can request that the user identify the payment credential 229 to be used for the proposed transaction at block 309. This step could be omitted or skipped in those situations where the request for the dETP 286 identifies the payment credential 229 with sufficient particularity. For example, if the request submitted at block 306 included the user identifier 223 of the user account and a partial payment credential identifier 289 (e.g., the last four digits of the account number for the payment credential 229), then this step might be skipped or omitted.

However, the payment authorization service 119 could alternatively prompt the user to identify or select the payment credential 229 to be used if the payment credential 229 was not identified (or sufficiently identified) in the request submitted at block 306. For example, the payment authorization service 119 could use the device identifiers 226 stored in association with the user account 216 of the user to send a message to the client application(s) 243 executing on the client device(s) 103 associated with the user. The message could cause the client application(s) 243 to notify the user of the need to select a payment credential 229 for use in the transaction. In response, the client application 243 could initiate a workflow to allow the user to select a payment credential 229 for use in the transaction and, therefore, inclusion in the dETP 286.

Moving on to block 313, the payment authorization service 119 can prepare an initial encrypted token payload (ETP). First, the payment authorization service 119 can create a token payload that includes the payment credential identifier 289 for the payment credential 229 to be used, the transaction amount 293 for the proposed transaction, and the merchant identifier 233 for the merchant associated with the transaction. Then, the payment authorization service 119 can encrypt the token payload with the bank encryption key 219 to generate the ETP.

Proceeding to block 316, the payment authorization service 119 can then send the ETP generated at block 313 to the client application 243 of a user associated with the payment credential 229 included within the ETP. For example, the payment authorization service 119 could identify a device identifier 226 associated with the user account 216 the is associated with the payment credential 229. The payment authorization service 119 could then send an approval or authorization request to the client application 243 executing on the client device 103 identified by the device identifier 226. The approval or authorization request could include the ETP as well as unencrypted versions of the merchant identifier 233 and the transaction amount 293 associated with the payment.

Accordingly, at block 323, the client application 243 can prompt the user to approve the ETP in order to create a dETP 286. For example, the client application 243 could show a message within a client interface 249 on the display 239 of the client device 103 a notification asking the user to approve the transaction. The notification message could include information about the transaction, such as the transaction amount 293 for the proposed transaction and the merchant associated with the proposed transaction based on the merchant identifier 233. The notification message could allow the user to approve the proposed transaction or reject the proposed transaction. In some instances, the user might need to login to or otherwise authenticate with the client application 243 prior to approving the proposed transaction. For example, the user could enter his or her username and password, or authenticate using biometrics (e.g., fingerprint identification, facial recognition, etc.).

If the user approves the proposed transaction, then the client application 243 can encrypt the ETP to create a dETP 286 at block 326. The dETP 286 could be created by encrypting the ETP using a variety of approaches. For example, the client application 243 could use the private encryption key 256 stored on the client device 103 to encrypt the ETP to create the dETP 286. If the private encryption key 256 is a single-use encryption key, then the client application 243 could prompt the user to enter a password, which could be used to generate a temporary private encryption key 256, or the client application 243 could generate a private encryption key 256 at random.

Moving on to block 329, the client application 243 can return the dETP 286 generated at block 326. If a single-use private encryption key 256 was used by the client application 243 to generate the dETP 286, then the key identifier for the single-use private encryption key 256 could also be returned to the payment authorization service 119.

Subsequently, at block 333, the payment authorization service 119 can return the dETP 286 to the payment initiator 303. If a key identifier for a single-use private encryption key 256 was returned by the client application 243 at block 329, then the key identifier for the private encryption key 256 can be returned to the payment initiator 303 as well. Similarly, if the bank encryption key 219 were a single-use encryption key, then the key identifier for the bank encryption key 219 could also be returned to the payment initiator 303. The payment authorization service 119 could also include the device identifier 226 of the client device 103 and the user identifier 223 of the user involved in encrypting the ETP to generate the dETP 286 at block 326.

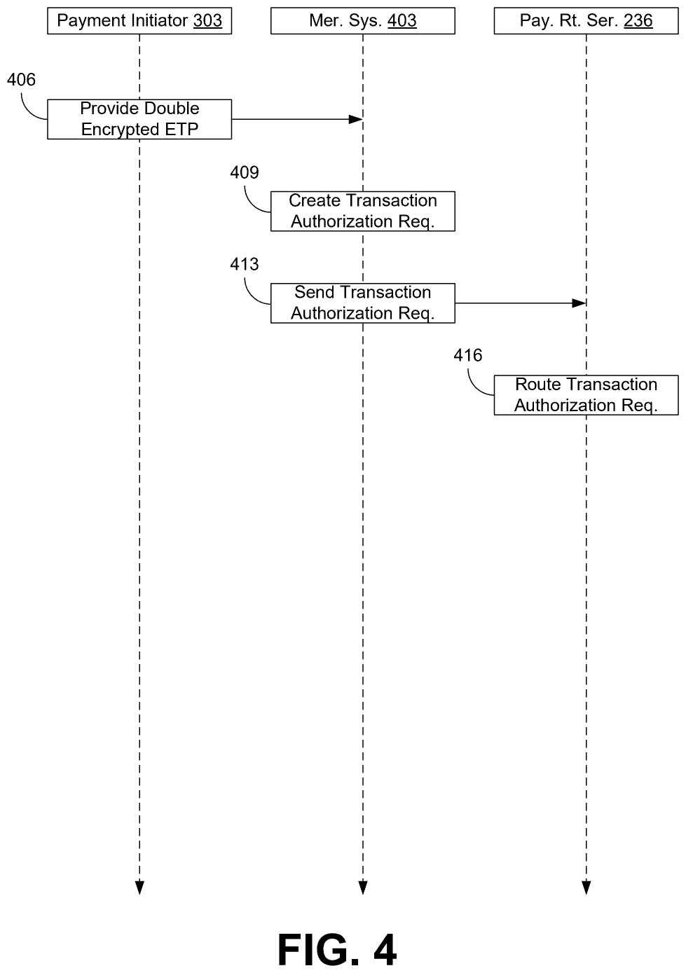

Referring next to FIG. 4, shown is a sequence diagram that provides one example of routing a transaction authorization request 273 containing a dETP 286 to the payment authorization service 119 for approval within the network environment 200. The sequence diagram of FIG. 4 provides merely an example of the many different types of functional arrangements that can be employed to implement the routing of a transaction authorization request 273 within the network environment 200. As an alternative, the sequence diagram of FIG. 4 can be viewed as depicting an example of elements of a method implemented within the network environment 200.

Beginning with block 406, the payment initiator 303 can provide the dETP 286 created using the process depicted in FIG. 3 to a merchant system 403 to make a purchase. The payment initiator 303 could also include the device identifier 226 of the client device 103 and the user identifier 223 of the user involved at block 326 (FIG. 3) in encrypting the ETP to generate the dETP 286 that is submitted to the merchant system 403.

A merchant system 403 can include any system operated by a merchant to accept and process payments. Examples of merchant systems 403 can include the checkout and payment processes and functionality of an electronic commerce system 109, a merchant PoS system 111, and/or other systems. For example, a payment initiator 303, such as a client application 243, browser 246, or an AI shopping assistant 106, could provide the dETP 286 to an electronic commerce system 109 of a merchant to pay for and complete a purchase. As another example, a payment initiator 303, such as a client device 103, could provide the dETP 286 to a merchant PoS system 111 (e.g., as part of an in-store purchase or transaction).

Then, at block 409, the merchant system 403 can create a transaction authorization request 273 for approval of the proposed transaction. The transaction authorization request 273 can include the dETP 286 and additional information for routing the transaction authorization request 273 to the appropriate payment processor service 113 for approval. This can include a payment network identifier 276 to identify the payment network 116 to route the payment request across (e.g., if the issuing bank for a credit, charge, or debit card participates in multiple payment networks 116), the payment processor identifier 279 for the payment processor service 113 of the issuing bank, and the user identifier 223 and/or device identifier 226 provided by the payment initiator 303 at block 406. As previously discussed with respect to FIG. 3, if a single-use private encryption key 256 or single-use bank encryption key 219 were used in the creation of the dETP 286, then the key identifier for the single-use private encryption key 256 or single-use bank encryption key 219 could also be included within the transaction authorization request 273. Additional information specifically requested or required by either the payment routing service 236 or the payment processor service 113 can also be included in various embodiments of the present disclosure. This could include, for example, the transaction amount 293 and the merchant identifier 233 duplicatively stored as part of the transaction authorization request 273 in unencrypted form outside of the dETP 286.

Next, at block 413, the merchant system 403 can submit or otherwise send the transaction authorization request 273 to the payment routing service 236 of the payment network 116 identified by the payment network identifier 276 included in the transaction authorization request 273. For example, the merchant system 403 could submit the transaction authorization request 273 to the payment routing service 236 using an API provided by the payment routing service 236.

Subsequently, at block 416, the payment routing service 236 can forward the transaction authorization request 273 to the appropriate payment processor service 113. For example, the payment routing service 236 could evaluate the transaction authorization request 273 to determine the payment processor identifier 279. The payment routing service 236 could then forward the transaction authorization request 273 to the payment processor service 113 identified by the payment processor identifier 279.

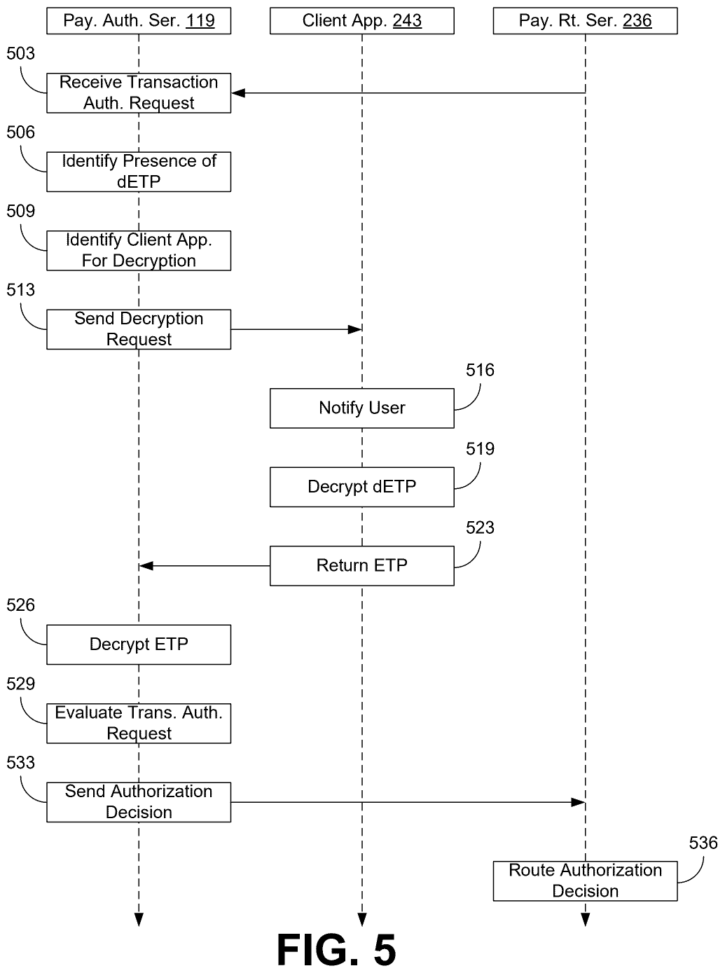

Referring next to FIG. 5, shown is a sequence diagram that illustrates the interactions between the payment authorization service 119, the client application 243, and the payment routing service 236 to authorize a payment using a double-encrypted token payload 286. The sequence diagram of FIG. 5 provides merely an example of the many different types of functional arrangements that can be employed to implement the authorization of a payment using a double-encrypted token payload 286. As an alternative, the sequence diagram of FIG. 5 can be viewed as depicting an example of elements of a method implemented within the network environment 200.

Beginning with block 503, the payment authorization service 119 can receive a transaction authorization request 273 form the payment routing service 236. This could occur, for example, in response to the payment routing service 236 forwarding the transaction authorization request to the payment authorization service 119 at block 416 (FIG. 4).

Then at block 506, the payment authorization service 119 can identify the presence of a dETP 286 within the transaction authorization request 273. This step could be performed in situations where the payment authorization service 119 receives a mix or combination of transaction authorization requests 273 that include a dETP 286 and transaction authorization requests 273 that do not include a dETP 286 (e.g., transaction authorization requests for transactions paid using preexisting authorization processes).

Moving on to block 509, the payment authorization service 119 can identity the appropriate client application 243 on the appropriate client device 103 that can perform a first or initial decryption of the dETP 286. For example, the payment authorization service 119 could determine the identity of the user and the client device 103 based on the user identifier 223 and the device identifier 226 within the transaction authorization request 273.

Subsequently, at block 513, the payment authorization service 119 can send a decryption request to the client application 243 identified at block 509. The decryption request can include the dETP 286 within the transaction authorization request 273. The decryption request could also include the identity of the merchant who is being paid, which could be determined based at least in part on the unencrypted version of the merchant identifier 233 included in the transaction authorization request 273, and the transaction amount 293. The amount of the transaction and the identity of the merchant requesting authorization for the transaction can be included in the decryption request to allow the user to determine whether he or she wishes to approve the decryption request-thereby validating, confirming, and/or approving the transaction. In some instances, the decryption request can also include a key identifier for the private encryption key 256 (e.g., if the private encryption key 256 used for encryption was a single-use encryption key).

Next, at block 516, the client application 243 can notify the user that the decryption request had been received and prompt the user to approve or reject the decryption request. To assist the user in deciding whether to approve or reject the decryption request, the client application 243 could present to the user amount of the transaction and the identity of the merchant seeking authorization for the transaction. In some implementations, the user of the client device 103 may be required to authenticate with the client application 243 (e.g., by inputting a username and password or using biometric authentication such as fingerprint identification or facial recognition) in order to view the notification in detail and/or approve or reject the decryption request.

Proceeding to block 519, the client application 243 can decrypt the dETP 286 using the private encryption key 256 if the user approved the decryption request. If the private encryption key 256 is a single-use encryption key, then the client application 243 can use the key identifier included in the decryption request to select the appropriate private encryption key 256. Similarly, if the private encryption key 256 were derived from a password or passphrase entered by the user, then the client application 243 could prompt the user to enter the password or passphrase and then generated the private encryption key 256 from the password or passphrase entered. Decryption of the dETP 286 with the private encryption key 256 can result in an encrypted token payload.

Then, at block 523, the client application 243 can return the encrypted token payload to the payment authorization service 119. For example, the client application 243 could send a response to the request received from the payment authorization service 119.

Accordingly, at block 526, the payment authorization service 119 can decrypt the encrypted token payload received from the client application 243 using the bank encryption key 219. If the bank encryption key 219 is a single-use encryption key, then the payment authorization service 119 can use the key identifier for the bank encryption key 219 included in the transaction authorization request to select the appropriate bank encryption key 219. In the event that decryption by both the client application 243 and the payment authorization service 119 is successful, then the unencrypted contents of the dETP 286 become available to the payment authorization service 119.

Next, at block 529, the payment authorization service 119 can evaluate the transaction authorization request 273 to determine whether to approve or reject it. For example, if the merchant identifier 233 or transaction amount 293 included in the dETP 286 fail to match the merchant identifier 233 or transaction amount 293 included in the transaction authorization request 273, then this could indicate that the transaction authorization request 273 is fraudulent and would result in a rejection. As another example, if the dETP 286 failed to successfully decrypt (e.g., the results were unintelligible), then this could indicate that the transaction authorization request 273 is fraudulent and would result in a rejection. Other types of credit, fraud, or risk checks could also be applied to the transaction authorization request 273 to determine whether it should be approved or denied. If the transaction authorization request 273 passes all applicable tests or checks, then the payment authorization service 119 can approve the transaction.

Moving on to block 533, the payment authorization service 119 can send an authorization decision to the payment routing service 236 of the payment network 116 that submitted the transaction authorization request. In turn, at block 536, the payment routing service 236 can route the authorization decision and return it to the applicable merchant system 403 in order to notify the merchant that the transaction was approved by the issuing bank.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a request for a double-encrypted token payload (dETP) from a payment initiator, the payment request comprising a merchant identifier and an amount of a transaction;
prepare an encrypted token payload (ETP) that represents the payment request and a payment credential, the ETP being encrypted with a first encryption key stored on the computing device;
send the ETP to a client application executing on a client device associated with an owner of the payment credential;
receive the dETP from the client application executing on the client device, the dETP being encrypted with a second encryption key stored on the client device; and
return the dETP to the payment initiator.

2. The system of claim 1, wherein the machine-readable instructions further cause the computing device to at least identify the client device associated with the owner of the payment credential.

3. The system of claim 1, wherein the machine-readable instructions further cause the computing device to at least:
receive a decryption request from a payment network for the dETP, the decryption request comprising the dETP;
forward the dETP to the client device associated with the owner of the payment credential;
receive the ETP from the client device in response to forwarding the dETP to the client device;
decrypt the ETP with the first encryption key to obtain the payment request; and
determine whether to authorize the payment request.

4. The system of claim 3, wherein the machine-readable instructions further cause the computing device to at least return an authorization message to the payment network for the payment request in response to a determination to authorize the payment request.

5. The system of claim 1, wherein the payment request further comprises a user identifier and the machine-readable instructions further cause the computing device to at least select the payment credential based at least in part on the user identifier.

6. The system of claim 1, wherein machine-readable instructions that cause the computing device to at least prepare the encrypted token payload (ETP) further cause the computing device to at least:
send a request for a selection of the payment credential to the client device; and
receive the selection of the payment credential from the client device.

7. The system of claim 1, wherein the first encryption key is a single use encryption key.

8. A method, comprising:
receiving a request for a double-encrypted token payload (dETP) from a payment initiator, the payment request comprising a merchant identifier and an amount of a transaction;
preparing an encrypted token payload (ETP) that represents the payment request and a payment credential, the ETP being encrypted with a first encryption key stored on the computing device;
sending the ETP to a client application executing on a client device associated with an owner of the payment credential;
receiving the dETP from the client application executing on the client device, the dETP being encrypted with a second encryption key stored on the client device; and
returning the dETP to the payment initiator.

9. The method of claim 8, further comprising identifying the client device associated with the owner of the payment credential.

10. The method of claim 8, further comprising:
receiving a decryption request from a payment network for the dETP, the decryption request comprising the dETP;
forwarding the dETP to the client device associated with the owner of the payment credential;
receiving the ETP from the client device in response to forwarding the dETP to the client device;
decrypting the ETP with the first encryption key to obtain the payment request; and
determining whether to authorize the payment request.

11. The method of claim 10, further comprising returning an authorization message to the payment network for the payment request in response to a determination to authorize the payment request.

12. The method of claim 8, wherein preparing the encrypted token payload (ETP) further comprises:
sending a request for a selection of the payment credential to the client device; and
receiving the selection of the payment credential from the client device.

13. The method of claim 8, wherein preparing an encrypted token payload (ETP) further comprises:
sending a request for a selection of the payment credential to the client device; and
receiving the selection of the payment credential from the client device.

14. The method of claim 8, wherein the first encryption key is a single use encryption key.

15. A non-transitory, computer-readable medium, comprising machine-readable instructions that, when executed by a processor of a computing device, cause the computing device to at least:
receive a request for a double-encrypted token payload (dETP) from a payment initiator, the payment request comprising a merchant identifier and an amount of a transaction;
prepare an encrypted token payload (ETP) that represents the payment request and a payment credential, the ETP being encrypted with a first encryption key stored on the computing device;
send the ETP to a client application executing on a client device associated with an owner of the payment credential;
receive the dETP from the client application executing on the client device, the dETP being encrypted with a second encryption key stored on the client device; and
return the dETP to the payment initiator.

16. The non-transitory, computer-readable medium of claim 15, wherein the machine-readable instructions further cause the computing device to at least identify the client device associated with the owner of the payment credential.

17. The non-transitory, computer-readable medium of claim 15, wherein the machine-readable instructions further cause the computing device to at least:
receive a decryption request from a payment network for the dETP, the decryption request comprising the dETP;
forward the dETP to the client device associated with the owner of the payment credential;
receive the ETP from the client device in response to forwarding the dETP to the client device;
decrypt the ETP with the first encryption key to obtain the payment request; and
determine whether to authorize the payment request.

18. The non-transitory, computer-readable medium of claim 17, wherein the machine-readable instructions further cause the computing device to at least return an authorization message to the payment network for the payment request in response to a determination to authorize the payment request.

19. The non-transitory, computer-readable medium of claim 15, wherein machine-readable instructions that cause the computing device to at least prepare the encrypted token payload (ETP) further cause the computing device to at least:
send a request for a selection of the payment credential to the client device; and
receive the selection of the payment credential from the client device.

20. The non-transitory, computer-readable medium of claim 15, wherein machine-readable instructions that cause the computing device to at least prepare an encrypted token payload (ETP) further cause the computing device to at least:
send a request for a selection of the payment credential to the client device; and
receive the selection of the payment credential from the client device.
